(19) United States
(12) Patent Application Publication
(10) Pub. No.: US 2025/0036549 A1
(43) Pub. Date: Jan. 30, 2025

(54) IDENTIFYING SURPRISING BEHAVIOR IN PROGRAM UPGRADES

(71) Applicant: Cisco Technology, Inc., San Jose, CA (US)

(72) Inventor: John Michael Lake, Cary, NC (US)

(21) Appl. No.: 18/620,350

(22) Filed: Mar. 28, 2024

Related U.S. Application Data
(60) Provisional application No. 63/516,448, filed on Jul. 28, 2023.

(51) Int. Cl. G06F 11/36

(52) U.S. Cl. CPC G06F 11/3636

(57) ABSTRACT

A system and method are provided for detecting surprising/anomalous behavior in an upgrade to a program. A first prediction model is obtained to predict the behavior of a current version of the program. A second prediction model is trained using event sets representing a partially or totally ordered set of events realized from executing the upgrade version of the program. First (second) predictions are generated by applying a given event set to the first (second) prediction model. The first predictions are then compared with the second predictions to determine whether the respective prediction agree. When they do not agree, the deviation in the program behavior is signaled (e.g., to an engineer). The first and second predictions can be conditional probabilities of the given event set, and they can be compared using a comparison metric that includes a difference between negative logarithms of the respective predictions.

### CROSS-REFERENCE TO RELATED APPLICATIONS

This application priority to U.S. provisional application No. 63/516,448, titled “Data Processing Units (DPUs) and extended Berkley Packet Filters (eBPFs) for Improved Security,” and filed on Jul. 28, 2023, which is expressly incorporated by reference herein in its entirety.

### TECHNICAL FIELD

Aspects described herein generally relate to detecting surprising/anomalous behavior in an upgrade to a program, and, including, aspects related to using prediction models for the current and upgraded versions of a program to predict events or event sets and signal a surprising/anomalous behavior when the predictions disagree between the models of the current and upgraded versions of the program.

### BACKGROUND

The software development life cycle (SDLC) provides a mechanism to introduce new features in a program and correct software bugs. Testing new software before and after deployment of the software provides checks to ensure the new version of the program is behaving as desired. These checks enable the detection of software bugs and vulnerabilities. Further ongoing monitoring can help to identify malicious activity and cyber attacks. A recurring challenge is discriminating between normal/desired behavior for the program and anomalous/undesirable behavior.

Accordingly, there is a need for methods and systems that can provide improved discrimination between normal/desired behavior for the program and anomalous/undesirable behavior. Further, there is a need for methods and systems that can robustly discriminate between normal/desired behavior for the program and anomalous/undesirable behavior without significant oversight and direction from a security operations center (SOC) or from a network operation center (NOC) engineer, for example.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example of a data center, in accordance with certain embodiments.

FIG. 2A illustrates a block diagram of a first example of a network, in accordance with certain embodiments.

FIG. 2B illustrates a block diagram of a second example of a network, in accordance with certain embodiments.

FIG. 3A illustrates a block diagram of an example of a extended Berkeley packet filter (eBPF) architecture, in accordance with some embodiments.

FIG. 3B illustrates a block diagram of another example of an eBPF architecture, in accordance with some embodiments.

FIG. 4 illustrates a flow diagram of a method for determining and using a prediction model of a program, in accordance with some embodiments.

FIG. 5 illustrates a flow diagram of a method for the software development life cycles, in accordance with some embodiments.

FIG. 6 illustrates a flow diagram of an example of a method for determining and using a prediction model of an upgrade to program to compare with a current version of the program, in accordance with some embodiments.

FIG. 7A illustrates a block diagram of an example of training a machine learning (ML) model to act as a behavior prediction model, in accordance with some embodiments.

FIG. 7B illustrates a block diagram of an example of using the trained ML model to predict the behavior of a program, in accordance with some embodiments.

FIG. 8 illustrates a block diagram of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method of detecting differences in behavior for a program, including: obtaining a first prediction model that predicts behavior of a first implementation of a program; obtaining an event sequence representing an ordered set (or event set representing a partially or totally ordered se) t of events realized from executing the program; determining, based on observations of a second implementation of the program, a second prediction model of a behavior of the second implementation of the program; generating, by the first prediction model, a first prediction based on the event sequence; generating, by the second prediction model, a second prediction based on the event sequence; comparing the first prediction with the second prediction to generate a first comparison result; signaling an unexpected behavior of the second implementation of the program when a value of the first comparison result is within a predefined behavior range that has been identified as corresponding to unexpected behavior.

In some aspects, the techniques described herein relate to a method, further including: generating, by the first prediction model, a first prediction of a next event (or subsequent event) that follows the event sequence; and generating, by the second prediction model, a second prediction of the next event that follows the event sequence.

In some aspects, the techniques described herein relate to a method, wherein the first prediction model is a statistical model that predicts first conditional probabilities of a plurality of next events given the event sequence, wherein a conditional probability of a next event of the plurality of next events is a probability of the next event occurring immediately after the event sequence; the second prediction model is a statistical model that predicts second conditional probabilities of the plurality of next events given the event sequence; and the value of the first comparison result is based on a norm of differences between first values based on the first conditional probabilities and second values based on the second conditional probabilities.

In some aspects, the techniques described herein relate to a method, wherein the first values are the first conditional probabilities and the first values are the second conditional probabilities; or the first values are logarithms of the first conditional probabilities and the second values are logarithms of the second conditional probabilities; or the first values are products of negatives of the first conditional probabilities times the logarithms of the first conditional probabilities and the second values are products of negatives of the second conditional probabilities times logarithms of the second conditional probabilities.

In some aspects, the techniques described herein relate to a method, wherein: the first implementation of the program is a current version of the program; the second implementation of the program is an upgrade version of the program; the program is executed in a cloud computing environment; and testing the upgrade version before committing the upgrade version to the cloud computing environment includes the comparing of the first prediction with the second prediction to generate the first comparison result and signaling the unexpected behavior of the second implementation of the program when the value of the first comparison result is within the predefined behavior range.

In some aspects, the techniques described herein relate to a method, wherein determining the second prediction model based on observations of a second implementation of the program includes: generating records of program traces representing respective sequences of events resulting from executing the second implementation of the program; mapping the records of program traces to canonical trace events to generate canonicalized records of trace events; and training the second prediction model using training data including the canonicalized records to predict likelihoods of next events in event sequences of the second implementation of the program or to predict which next events are unsurprising for respective event sequences of the second implementation.

In some aspects, the techniques described herein relate to a method, further including: predicting a confidence metric of the second prediction model; determining the second prediction is reliable when the confidence metric is within a predefined confidence range; signaling the unexpected behavior of the second implementation of the program when both the confidence metric is within the predefined confidence range and the value of the first comparison result is within the predefined behavior range; and signaling that the second prediction is indeterminate when the confidence metric is outside the predefined confidence range.

In some aspects, the techniques described herein relate to a method, further including: comparing second prediction to an actual next event of the second implementation of the program that follows the event sequence, and thereby generating a second comparison result; signaling an unexpected behavior of the second implementation of the program when the value of the comparison result is within the predefined behavior range and the second comparison result is within a predefined surprise range; and signaling an expected deviation of the second implementation of the program when the value of the comparison result is within the predefined behavior range and the second comparison result is outside the predefined surprise range.

In some aspects, the techniques described herein relate to a method, further including: comparing the first prediction to an actual next event of the second implementation of the program immediately following the event sequence to generate a third comparison result; and signaling an expected deviation of the second implementation of the program when the value of the comparison result is within the predefined behavior range, the third comparison result is outside the predefined surprise range, and the second comparison result is within the predefined surprise range.

In some aspects, the techniques described herein relate to a computing apparatus including: a processor; and a memory storing instructions that, when executed by the processor, configure the apparatus to: obtain a first prediction model that predicts behavior of a first implementation of a program; obtain an event sequence representing an ordered set of events realized from executing the program; determine, based on observations of a second implementation of the program, a second prediction model of a behavior of the second implementation of the program; and generate, by the first prediction model, a first prediction based on the event sequence; generate, by the second prediction model, a second prediction based on the event sequence; compare the first prediction with the second prediction to generate a first comparison result; signal an unexpected behavior of the second implementation of the program when a value of the first comparison result is within a predefined behavior range that has been identified as corresponding to unexpected behavior.

In some aspects, the techniques described herein relate to a computing apparatus, wherein the instructions stored in the memory further configure the apparatus to: generate, by the first prediction model, a first prediction of a next event that follows the event sequence; and generate, by the second prediction model, a second prediction of the next event that follows the event sequence.

In some aspects, the techniques described herein relate to a computing apparatus, wherein the first prediction model is a statistical model that predicts first conditional probabilities of a plurality of next events given the event sequence, wherein a conditional probability of a next event of the plurality of next events is a probability of the next event occurring immediately after the event sequence; the second prediction model is a statistical model that predicts second conditional probabilities of the plurality of next events given the event sequence; and the value of the first comparison result is based on a norm of differences between first values based on the first conditional probabilities and second values based on the second conditional probabilities.

In some aspects, the techniques described herein relate to a computing apparatus, wherein the first values are the first conditional probabilities and the first values are the second conditional probabilities; or the first values are logarithms of the first conditional probabilities and the second values are logarithms of the second conditional probabilities; or the first values are products of negatives of the first conditional probabilities times the logarithms of the first conditional probabilities and the second values are products of negatives of the second conditional probabilities times logarithms of the second conditional probabilities.

In some aspects, the techniques described herein relate to a computing apparatus, wherein: the first implementation of the program is a current version of the program; the second implementation of the program is an upgrade version of the program; the program is executed in a cloud computing environment; and the instructions stored in the memory further configure the apparatus to test the upgrade version before committing the upgrade version to the cloud computing environment includes the comparing of the first prediction with the second prediction to generate the first comparison result and signaling the unexpected behavior of the second implementation of the program when the value of the first comparison result is within the predefined behavior range.

In some aspects, the techniques described herein relate to a computing apparatus, wherein the instructions stored in the memory further configure the apparatus to determine the second prediction model based on observations of a second implementation of the program by: generating records of program traces representing respective sequences of events resulting from executing the second implementation of the program; mapping the records of program traces to canonical trace events to generate canonicalized records of trace events; and training the second prediction model using training data including the canonicalized records to predict likelihoods of next events in event sequences of the second implementation of the program or to predict which next events are unsurprising for respective event sequences of the second implementation.

In some aspects, the techniques described herein relate to a non-transitory computer-readable storage medium, the computer-readable storage medium including instructions that when executed by a computer, cause the computer to: obtain a first prediction model that predicts behavior of a first implementation of a program; obtain an event sequence representing an ordered set of events realized from executing the program; determine, based on observations of a second implementation of the program, a second prediction model of a behavior of the second implementation of the program; generate, by the first prediction model, a first prediction based on the event sequence; generate, by the second prediction model, a second prediction based on the event sequence; comparing the first prediction with the second prediction to generate a first comparison result; and signal an unexpected behavior of the second implementation of the program when a value of the first comparison result is within a predefined behavior range that has been identified as corresponding to unexpected behavior.

In some aspects, the techniques described herein relate to a non-transitory computer-readable storage medium, wherein the instructions on computer-readable storage medium further cause the computer to: generate, by the first prediction model, a first prediction of a next event that follows the event sequence; and generate, by the second prediction model, a second prediction of the next event that follows the event sequence.

In some aspects, the techniques described herein relate to a non-transitory computer-readable storage medium, wherein the first prediction model is a statistical model that predicts first conditional probabilities of a plurality of next events given the event sequence, wherein a conditional probability of a next event of the plurality of next events is a probability of the next event occurring immediately after the event sequence; the second prediction model is a statistical model that predicts second conditional probabilities of the plurality of next events given the event sequence; and the value of the first comparison result is based on a norm of differences between first values based on the first conditional probabilities and second values based on the second conditional probabilities.

In some aspects, the techniques described herein relate to a non-transitory computer-readable storage medium, wherein the first values are the first conditional probabilities and the first values are the second conditional probabilities; or the first values are logarithms of the first conditional probabilities and the second values are logarithms of the second conditional probabilities; or the first values are products of negatives of the first conditional probabilities times the logarithms of the first conditional probabilities and the second values are products of negatives of the second conditional probabilities times logarithms of the second conditional probabilities.

In some aspects, the techniques described herein relate to a non-transitory computer-readable storage medium, wherein the instructions on computer-readable storage medium further cause the computer to determine the second prediction model based on observations of a second implementation of the program by: generating records of program traces representing respective sequences of events resulting from executing the second implementation of the program; mapping the records of program traces to canonical trace events to generate canonicalized records of trace events; and training the second prediction model using training data including the canonicalized records to predict likelihoods of next events in event sequences of the second implementation of the program or to predict which next events are unsurprising for respective event sequences of the second implementation.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improved methods of discriminating between normal/desired behavior and anomalous/undesirable behavior for programs and program upgrades. Thus, the methods and systems disclosed herein provide detection of surprising events in program traces, for example.

Further, there is a need for methods and systems that can robustly discriminate between normal/desired behavior for the program and anomalous/undesirable behavior without significant oversight and direction from a security operations center (SOC) or from a network operation center (NOC) engineers. Accordingly, the methods and systems disclosed herein provide a way for a prediction model to learn what is normal behavior of the program and detect deviations from the normal behavior. Further, the methods and systems disclosed herein provide detection of when an upgrade to the program behaves differently from the current version of the program. These models of the program (and program upgrade) behavior can be realized with little human oversight or direction.

A recurring problem for a security operations center (SOC) or for network operation center (NOC) engineers is identifying anomalous events. Identifying such anomalous events can be an early step in detecting software bugs, vulnerabilities in software, and potential cyber attacks. The problem of anomalous event detection can occur at different levels. For example, an anomalous event can occur within the context of an individual program. For example, a program behaving in an unexpected way can be an indicator of malicious activity.

At a higher level, an anomalous event can occur within the context of multiple programs, when one of the programs exhibits behavior that unexpectedly deviates in a significant manner relative to other programs. For example, when the upgrade to a program behaves differently than the current version of the program, the deviation in behavior can either result from fixing a bug in the earlier version or introducing a new bug in the upgraded version of the program. Detecting changes in the program's behavior can present a challenge, especially if the NOC engineer or other professional is tasked with characterizing what is considered normal versus anomalous behavior. For example, it can be challenging to rapidly sort through a large amount of telemetry data (e.g., program traces) to discriminate between when the software is operating anomalously. To address this challenge, the methods and systems disclosed herein use observations of the program to train a prediction model that generates predictions regarding the program's behavior.

According to certain non-limiting examples, the methods and systems disclosed herein identify surprising behavior in program upgrades by developing a model that predicts normal behavior for the program upgrade and signals unexpected events when the actual behavior diverges significantly from the predicted behavior. Further, deviations in the behavior of the program upgrade relative to the current program can be identified by comparing the predictions of the program-upgrade model with the predictions of the current-program model, when the respective predictions deviate significantly, the upgrade behavior can be flagged as either an expected or unexpected deviation.

Because this approach learns the model for what constitutes normal behavior from actual programs, this approach can be both flexible and robust. For example, this approach generalizes to many different types of programs and situations because it does not depend on any underlying assumptions about the programs. Further, this lack of assumptions or a prior definitions regarding what is deviant behavior enables this approach to be robust for both well-known and nascent bugs and vulnerabilities. That is, this approach can be flexible because it learns from the software itself what is normal behavior and develops a model of this normal behavior. Then this learned model is used to monitor the software's subsequent behavior to detect deviations from the normal behavior.

The methods and systems disclosed herein can be useful for customers of cloud computing services who wish to deploy their programs in a cloud computing environment. For example, after developing their programs, the customers can use the methods and systems disclosed herein to test and verify the desired behavior of their programs in the cloud computing environment. Further, the methods and systems disclosed herein can be used for continuous monitoring of the customers' program and upgrades to said programs to alert them of potential issues.

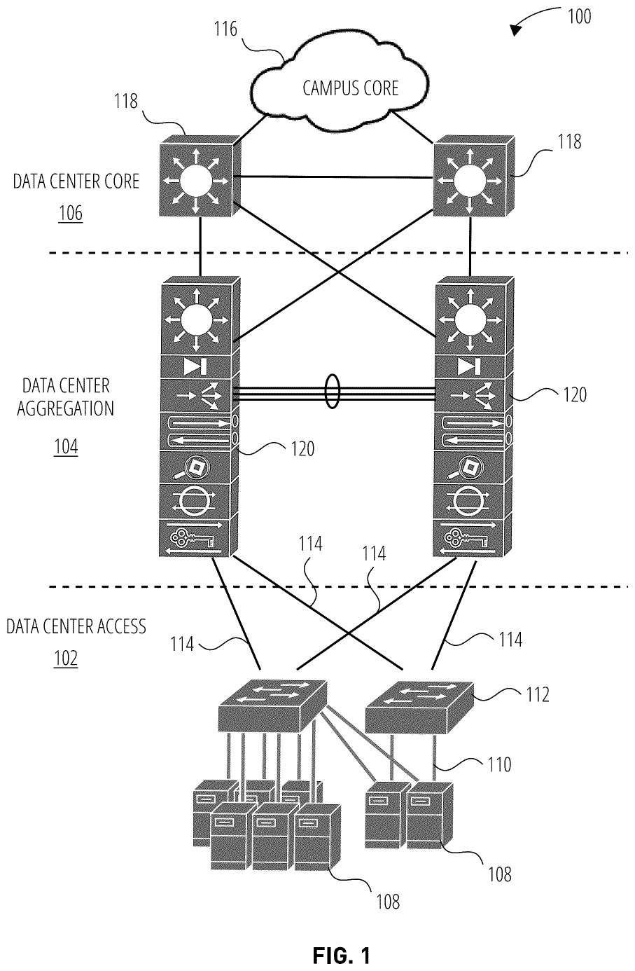

FIG. 1 illustrates a non-limiting example of a multi-tier data center 100, which includes data center access 102, data center aggregation 104, and data center core 106. The data center 100 provides computational power, storage, and applications that can support an enterprise business, for example.

The network design of the data center 100 can be based on a layered approach. The layered approach can provide improved scalability, performance, flexibility, resiliency, and maintenance. As shown in FIG. 1, the layers of the data center 100 can include the core, aggregation, and access layers (i.e., data center core 106, data center aggregation 104, and data center access 102).

The data center core 106 layer includes multilayer switches 118, providing the high-speed packet switching backplane for all flows going in and out of the data center 100. The data center core 106 can provide connectivity to multiple aggregation modules and provides a resilient Layer 3 routed fabric with no single point of failure. The data center core 106 can run an interior routing protocol, such as Open Shortest Path First (OSPF) or Enhanced Interior Gateway Routing Protocol (EIGRP), and load balances traffic between the campus core and aggregation layers using forwarding-based hashing algorithms, for example.

The data center aggregation 104 layer can provide functions such as service module integration, Layer 2 domain definitions, spanning tree processing, and default gateway redundancy. Server-to-server multi-tier traffic can flow through the aggregation layer and can use services, such as firewall and server load balancing, to optimize and secure applications. The smaller icons within the aggregation layer switch in FIG. 1 represent the integrated service modules. These modules provide services, such as content switching, firewall, SSL offload, intrusion detection, network analysis, and more.

The data center access 102 layer is where the servers physically attach to the network. The server components can be, e.g., 1RU servers, blade servers with integral switches, blade servers with pass-through cabling, clustered servers, and mainframes with OSA adapters The access layer network infrastructure can include modular switches, fixed configuration 1 or 2RU switches, and integral blade server switches. Switches provide both Layer 2 and Layer 3 topologies, fulfilling the various server broadcast domain or administrative requirements.

The architecture in FIG. 1 is an example of a multi-tier data center, but server cluster data centers can also be used. The multi-tier approach can include web, application, and database tiers of servers. The multi-tier model can use software that runs as separate processes on the same machine using inter-process communication (IPC), or the multi-tier model can use software that runs on different machines with communications over the network. Typically, the following three tiers are used: (i) Web-server; (ii) Application; and (iii) Database. Further, multi-tier server farms built with processes running on separate machines can provide improved resiliency and security. Resiliency is improved because a server can be taken out of service while the same function is still provided by another server belonging to the same application tier. Security is improved. For example, an attacker can compromise a web server without gaining access to the application or database servers. Web and application servers can coexist on a common physical server, but the database typically remains separate. Load balancing the network traffic among the tiers can provide resiliency, and security is achieved by placing firewalls between the tiers. Additionally, segregation between the tiers can be achieved by deploying a separate infrastructure composed of aggregation and access switches, or by using virtual local area networks (VLANs). Further, physical segregation can improve performance because each tier of servers is connected to dedicated hardware. The advantage of using logical segregation with VLANs is the reduced complexity of the server farm. The choice of physical segregation or logical segregation depends on your specific network performance requirements and traffic patterns.

The data center access 102 includes one or more access server clusters access server cluster 108, which can include layer 2 access with clustering and network interface controller (NIC) teaming. The access server clusters access server cluster 108 can be connected via gigabit ethernet (GigE) connections 110 to the workgroup switches workgroup switch 112. The access layer provides the physical level attachment to the server resources and operates in Layer 2 or Layer 3 modes for meeting particular server requirements such as NIC teaming, clustering, and broadcast containment.

The data center aggregation 104 can include aggregation processor 120, which is connected via 10 gigabit ethernet (10 GigE) connections 114 to the data center access 102 layer.

The aggregation layer can be responsible for aggregating the thousands of sessions leaving and entering the data center. The aggregation switches can support, e.g., many 10 GigE and GigE interconnects while providing a high-speed switching fabric with a high forwarding rate. The aggregation processor 120 can provide value-added services, such as server load balancing, firewalling, and SSL offloading to the servers across the access layer switches. The switches of the aggregation processor 120 can carry the workload of spanning tree processing and default gateway redundancy protocol processing.

For an enterprise data center, the data center aggregation 104 can contain at least one data center aggregation module that includes two switches (i.e., aggregation processor 120). The aggregation switch pairs work together to provide redundancy and to maintain the session state. For example, the platforms for the aggregation layer include the CISCO CATALYST 6509 and CISCO CATALYST 6513 switches equipped with SUP720 processor modules. The high switching rate, large switch fabric, and ability to support a large number of 10 GigE ports are important requirements in the aggregation layer. The aggregation processor 120 can also support security and application devices and services, including, e.g.: (i) Cisco Firewall Services Modules (FWSM); (ii) Cisco Application Control Engine (ACE); (iii) Intrusion Detection; (iv) Network Analysis Module (NAM); and (v) Distributed denial-of-service attack protection.

The data center core 106 provides a fabric for high-speed packet switching between multiple aggregation modules. This layer serves as the gateway to the campus core 116 where other modules connect, including, For example, the extranet, wide area network (WAN), and internet edge. Links connecting the data center core 106 can be terminated at Layer 3 and use 10 GigE interfaces to support a high level of throughput, performance, and to meet oversubscription levels. According to certain non-limiting examples, the data center core 106 is distinct from the campus core 116 layer, with different purposes and responsibilities. A data center core 106 is not necessarily required, but is recommended when multiple aggregation modules are used for scalability. Even when a small number of aggregation modules are used, it might be appropriate to use the campus core for connecting the data center fabric.

The data center core 106 layer can connect, e.g., to the campus core 116 and data center aggregation 104 layers using Layer 3-terminated 10 GigE links. Layer 3 links can be used to achieve bandwidth scalability, quick convergence, and to avoid path blocking or the risk of uncontrollable broadcast issues related to extending Layer 2 domains.

The traffic flow in the core can include sessions traveling between the campus core 116 and the aggregation processors 120. The data center core 106 aggregates the aggregation module traffic flows onto optimal paths to the campus core 116. Server-to-server traffic can remain within an aggregation processor 120, but backup and replication traffic can travel between the aggregation processors 120 by way of the data center core 106.

A computer network is a geographically distributed collection of nodes interconnected by communication links and segments for transporting data between end nodes, such as personal computers, cellular phones, workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

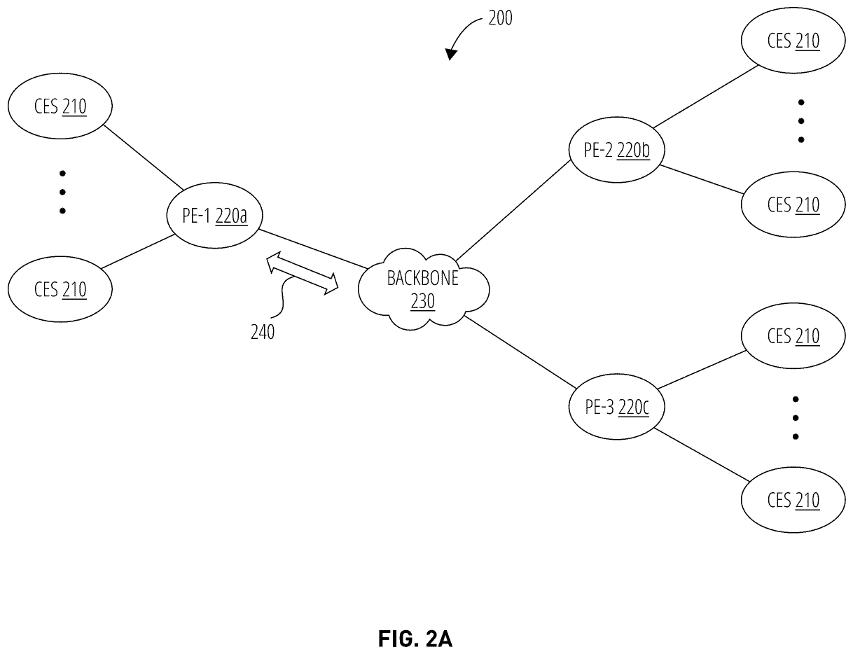

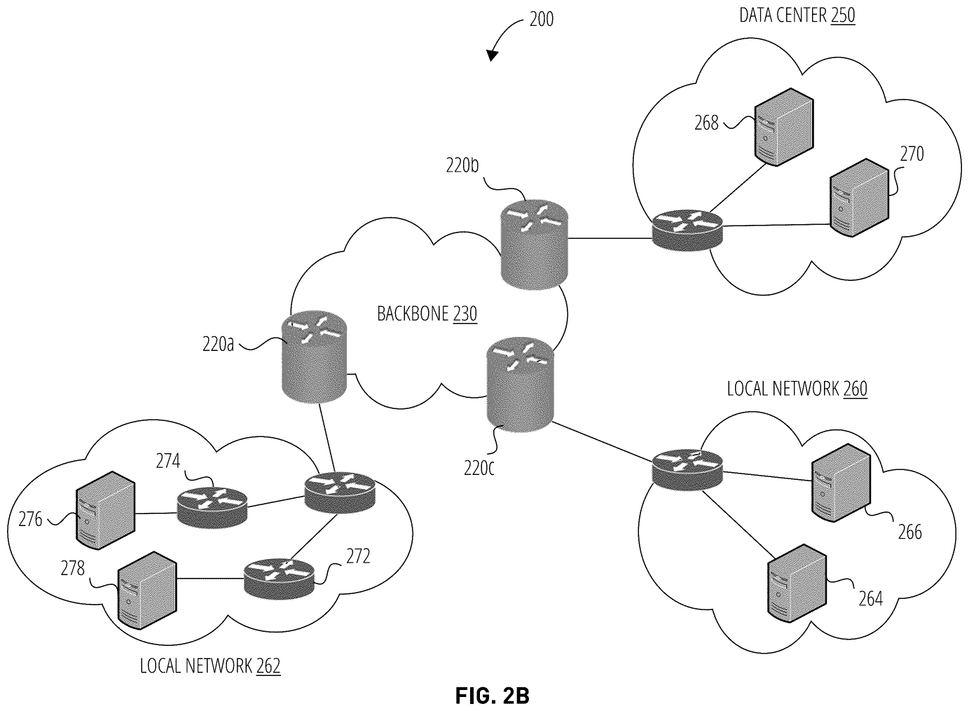

FIG. 2A is a schematic block diagram of a non-limiting example of a computer network 200 that includes various nodes/devices, such as a plurality of routers/devices interconnected by links or networks. For example, customer edge (CE) routers 210 may be interconnected with provider edge (PE) routers (e.g., PE-1 220a, PE-2 220b, and PE-3 220c) to communicate across a core network, such as an illustrative network backbone 230. Note, PE-1 220a, PE-2 220b, and PE-3 220c can be collectively referred to as PE routers 220. For example, the routers (e.g., CE routers 210 and/or PE routers 220) may be interconnected by the public Internet, a multiprotocol label switching (MPLS), or a virtual private network (VPN). Data packets 240 (e.g., traffic/messages) may be exchanged among the nodes/devices of the computer network 200 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics.

According to certain non-limiting examples, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 210 shown in network 200 may support a given customer site, potentially also with a backup link, such as a wireless connection.

2.) Site Type B: a site connected to the network using two MPLS VPN links (e.g., from different Service Providers) using a single CE router, with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 200 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 210 connected to PE-2 220b and a second CE router 210 connected to PE-3 220c.

FIG. 2B illustrates an example of computer network 200 in greater detail, according to various embodiments. As shown, network backbone 230 may provide connectivity between devices located in different geographical areas and/or different types of local networks. For example, network 200 may comprise local/branch networks 260 and 262 that include devices/nodes 272, 274, 276, and 278 and devices/nodes 264 and 266, respectively, as well as a data center 250 (e.g., a cloud environment) that includes servers 268 and 270. Notably, local network 260, local network 262, and data center 250 can be located in different geographic locations.

Server 268 and server 270 can include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 200 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, computer network 200 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often deployed on what are referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 260 may be an LLN in which CE-2 operates as a root node for devices/nodes 266 and 264 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QOS), security, network management, and traffic engineering extremely challenging, to mention a few.

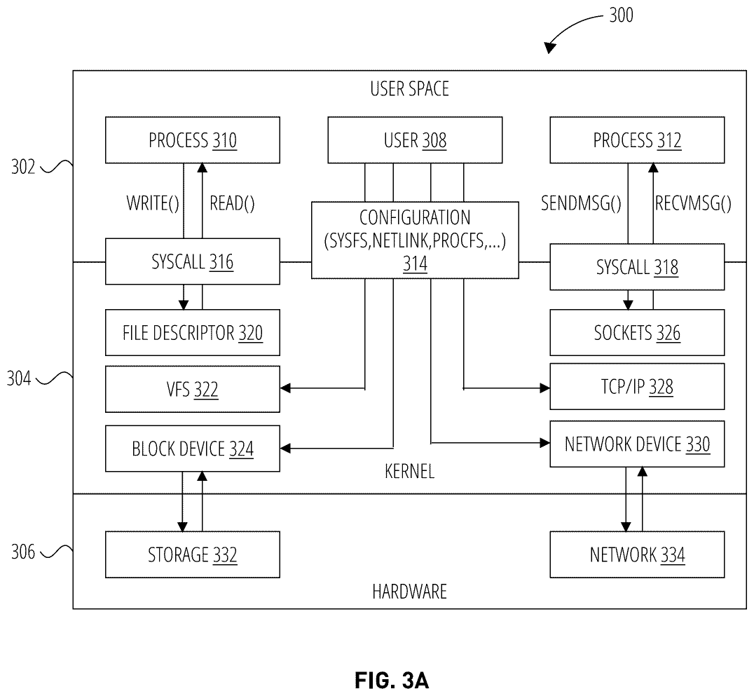

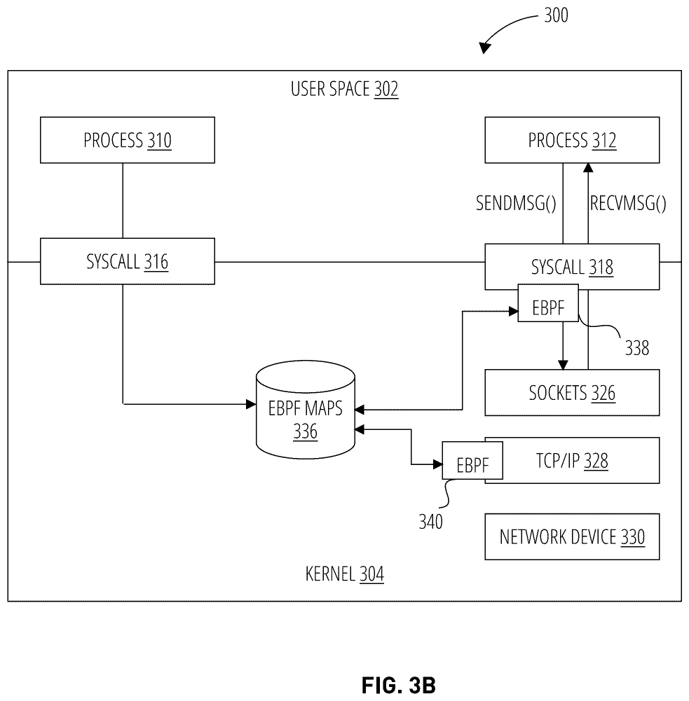

FIG. 3A illustrates a non-limiting example of implementing extended Berkley pack filters (eBPF). The eBPF architecture 300 can be implemented on a central processing unit (CPU and includes a user space 302, Kernel 304, and hardware 306. For example, the user space 302 can be a place where regular applications run, whereas the kernel 304 is where most operating system-related processes run.

The kernel 304 can have direct and full access to the hardware 306. When a given application in user space 302 connects to hardware 306, the application can do so via calling APIs in kernel 304. Separating the application and the hardware 306 can provide security benefits. An eBPF can allow user-space applications to package the logic to be executed in the kernel 304 without changing the kernel code or reloading.

Since eBPF programs run in the kernel 304, the eBPF programs can have visibility across all processes and applications, and, therefore, they can be used for many things: network performance, security, tracing, and firewalls.

The user space 302 can include a process 310, a user 308, and process 312. The kernel 304 can include a 320, a virtual file system (VFS) 322, a block device 324, sockets 326, a TCP/IP 328, and a network device 330. The hardware 306 can include storage 332 and network 334.

eBPF programs are event-driven and are run when the kernel or an application passes a certain hook point. Pre-defined hooks include system calls, function entry/exit, kernel tracepoints, network events, and several others. If a predefined hook does not exist for a particular need, it is possible to create a kernel probe (kprobe) or user probe (uprobe) to attach eBPF programs almost anywhere in kernel or user applications. When the desired hook has been identified, the eBPF program can be loaded into the kernel 304 using the bpf system call (e.g., syscall 316 or 318). This is typically done using one of the available eBPF libraries. The next section provides an introduction into the available development toolchains. Verification of the eBPF program ensures that the eBPF program is safe to run. It validates that the program meets several conditions (e.g., the conditions can be that the process loading the eBPF program holds the required capabilities/privileges; the program does not crash or otherwise harm the system; and the program always runs to completion).

A benefit of the kernel 304 is abstracting the hardware (or virtual hardware) and providing a consistent API (system calls) allowing for applications to run and share the resources. To achieve this, a wide set of subsystems and layers are maintained to distribute these responsibilities. Each subsystem can allow for some level of configuration (e.g., configuration 314) to account for different needs of users. When a desired behavior cannot be configured, the kernel 304 can be modified to perform the desired behavior. This modification can be realized in three different ways: (1) by changing kernel source code, which may take a long time (e.g., several years) before a new kernel version becomes available with the desired functionality; (2) writing a kernel module, which may require regular editing (e.g., every kernel release) and incurs the added risk of corrupting the kernel 304 due to lack of security boundaries; or (3) writing an eBPF program that realizes the desired functionality. Beneficially, eBPF allows for reprogramming the behavior of the kernel 304 without requiring changes to kernel source code or loading a kernel module.

Many types of eBPF programs can be used, including socket filters and system call filters, networking, and tracing. Socket filter type eBPF programs can be used for network traffic filtering, and can be used for discarding or trimming of packets based on the return value. XDP type eBPF programs can be used to improve packet processing performance by providing a hook closer to the hardware (at the driver level), e.g., to access a packet before the operative system creates metadata. Tracepoint type eBPF programs can be used instrument kernel code, e.g., by attaching an eBPF program when a “perf” event is opened with a command “perf_event_open(2)”, then use the command “ioctl(2)” to return a file descriptor that can be used to enable the associated individual event or event group and to attach the eBPF program to the tracepoint event. Helper type eBPF programs can be used to determines which subset of in kernel functions can be called. Helper functions are called from within eBPF programs to interact with the system, to operate on the data passed as context, or to interact with maps.

FIG. 3B illustrates just-in-time (JIT) compilation of eBPF programs. JIT compilation translates the generic bytecode of the program into the machine specific instruction set to optimize execution speed of the program. This makes eBPF programs run as efficiently as natively compiled kernel code or as code loaded as a kernel module.

An aspect of eBPF programs is the ability to share collected information and to store state information. For example, eBPF programs can leverage eBPF maps 336 to store and retrieve data in a wide set of data structures. The eBPF maps 336 can be accessed from eBPF program 338 and eBPF program 340 as well as from applications (e.g., process 310 and process 312) in user space 302 via a system call (e.g., syscall 316 and syscall 318). Non-limiting examples of supported map types include, e.g., hash tables, arrays, least recently used (LRU), ring buffer, stack trace, and longest prefix match (LPM), which illustrates the diversity of data structures supported by eBPF programs.

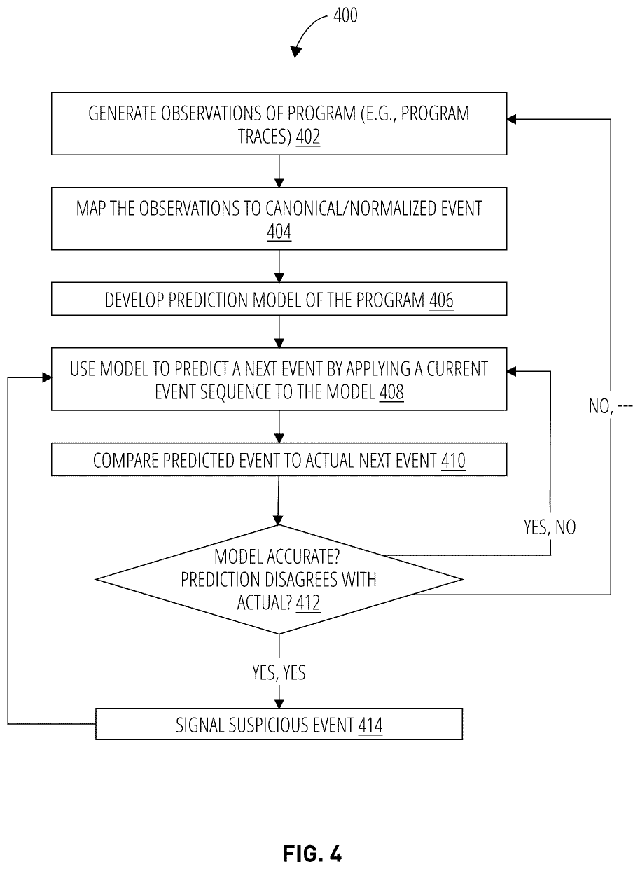

FIG. 4 illustrates an example a method 400 for identifying surprise in the behavior of a program. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to certain non-limiting examples, the program can be implemented as a dynamically invoked to perform a specific task, Additionally or alternatively, the program can be implemented as a persistently available program. For example, the program can be a customer program (e.g., software as a service) that is executed in a cloud computing environment. For example, the program can be a customer program that is executed on the access server cluster 108 of data center 100 or on a server 268 of data center 250. A customer can seek to detect surprising behavior in their program or seek to test a new version of their program before committing and deploying the software. Method 400 or method 600 (discussed below) can be used, e.g., to detect a software exploit of the customer's program or a bug in the new version of the customer's program.

According to some examples, in step 402, observations of the program (e.g., program traces) are generated. These observations can be records of actions or steps executed by the program. These records can be event sequences or program traces that are generated by an eBPF program, for example. Further, the observations of the program can be event sequences generated from telemetry data representing actions taken by the program.

The program can have a set of operational modes that can be characterized at different levels of abstraction. One level of abstraction is the program trace. Many aspects of the program's behavior can be captured, at least in part, by examining program traces, which can refer to, e.g., the sequence of branch instructions taken, the sequence of functions called, the sequence of interactions between communicating cooperating processes. Examples of program traces can include, e.g., truss, strace, dtrace, and eBPF-style data capture.

For example, dtrace can provide a comprehensive dynamic tracing framework originally for troubleshooting kernel and application problems on production systems. Dtrace can be used to get a global overview of a running system, such as the amount of memory, CPU time, filesystem and network resources used by the active processes. It can also provide much more fine-grained information, such as a log of the arguments with which a specific function is being called, or a list of the processes accessing a specific file. Similar to dtrace, bpftrace is high-level tracing front-end that lets you analyze systems in custom ways, and it has been referred to as dtrace version 2.0 (i.e., bpftrace is more capable than dtrace). For example, bpftrace is built from the ground up for the modern era of the eBPF virtual machine.

Further, strace is a diagnostic, debugging and instructional user space utility for Linux that can be used to monitor interactions between processes and the Linux kernel, which include system calls, signal deliveries, and changes of process state. The truss command can be used to trace the FreeBSD or Solaris Unix system calls called by the specified process or application.

According to certain non-limiting examples, the program can route data packets within a network such that, after a certain event sequence, the program connects a first host in the network to one of the hosts in a given cluster, which includes a second host, a third host, and a fourth host. In this example, the observations can include hundreds of occurrences of the certain event sequence being followed by the first host in the network being connected to one of the hosts in the given cluster, with 35 occurrences of the first host being connected to one of the second host, 60 occurrences of the first host being connected to the third host, and five occurrences of the first host being connected to the fourth host.

In step 404 of method 400, the observations are mapped to canonical/normalized event. For example, the observations can be even sequences or program traces, which can be expressed in various ways, and the mapping can unify these various types or standards of expressing program traces to a common set of event types and ways of expressing those event types. This can be referred to as normalizing or canonicalizing the program traces. And the canonicalized program traces will then be used as a corpus of training data that is used to generate the models in the next step.

In step 406 of method 400, a prediction model is developed based on the observations to predict the next event. For example, the prediction model is developed based on the observations of the program (e.g., the program traces or the canonicalized program traces). The prediction model can be a probabilistic model that given a sequence of events predicts possible next events together with values representing respective likelihoods of those possible being the next event after the given sequence of events. Alternatively, the prediction model can be a look-up-table model that provides a set of likely events that can be the next event following the given sequence of events.

Returning now to the example of the program observations including hundreds of occurrences of the certain event sequence in which the next event is: (i) 35 occurrences of the first host being connected to one of the second host, (ii) 60 occurrences of the first host being connected to the third host, and (iii) five occurrences of the first host being connected to the fourth host. In this example, the prediction model can learn that these three events (i.e., the first host connecting with one of the second third, or fourth hosts) are likely next events, and that the likelihoods/probabilities of these three next events are respectively 35%, 60%, and 5%.

According to certain non-limiting examples, the prediction model can be based on the dynamic construction of a Markov model. For example, the prediction model can be constructed as a model giving the probability of an event [n] conditioned by the preceding n−1 events:

$$P ( event [ n ] \vert event [ n - 1 ] , … , event [ 1 ] )$$

This type of Markov model can be dynamically trained by holding aside a small amount of probability for unseen events (e.g., the probability of an event that has not yet been observed can be set to the value P(unseen)=1/(N+1) or P(unseen)=1/(N+k(N)), where N is the number of observed events and k(N) is a function of N). According to certain non-limiting examples, the Markov models can be prefix tree (trie)-structured model. A trie (which is also called digital tree or prefix tree) is a type of k-ary search tree. That is, a tree data structure that can be used for locating specific keys from within a set, and nodes within the trie can be events.

According to certain non-limiting examples, the Markov models can use Angluin's constructions of regular automata from observations (e.g., augmented with synthesized pseudo-negative examples).

According to certain non-limiting examples, the prediction model can be a Bayesian network or a probabilistic graphical model. For example, the Bayesian network can update the expectation values of event [n] given the sequence of (event [n−1], . . . , event [1]) using an expectation-maximization (EM) process. The EM) process can use an iterative method to find (local) maximum likelihood or maximum a posteriori (MAP) estimates of parameters in statistical models, where the model depends on unobserved latent variables. The EM iteration alternates between performing an expectation (E) step, which creates a function for the expectation of the log-likelihood evaluated using the current estimate for the parameters, and a maximization (M) step, which computes parameters maximizing the expected log-likelihood found on the E step. These parameter estimates are then used to determine the distribution of the latent variables in the next E step.

According to certain non-limiting examples, the prediction model can use a transformer neural network to predict the next event (e.g., event [n]) after a given sequence of events (e.g., event [n−1], event [n−2], . . . , event [1]).

According to certain non-limiting examples, the prediction model can use a generative adversarial network to predict the next event (e.g., event [n]) after a given sequence of events (e.g., event [n−1], event [n−2], . . . , event [1]).

According to certain non-limiting examples, the prediction model is a look-up table that includes observed events that follow the given event sequence. For example, when the observations include an observed event that occurs at least a minimum threshold (e.g., the minimum threshold can be a minimum percentage or can be a simple as appearing even just one time) after the given sequence then the observed event is entered into the look-up table as being a known/unsurprising next event. In this example, the prediction model returns only the predictions of possible (i.e., known/unsurprising) next events and does not return the likelihoods of the possible next events.

According to some examples, in step 408, the prediction model is used to predict the next event by applying a current event sequence to the model. The event sequence can be an actual event sequence of the program (e.g., the current program trace or the current observation of the program)

According to some examples, in step 410, the predicted event from step 408 is compared to the actual next event that is determined by executing the program. Based on this comparison, the actual next event can be determined to be either a surprising event or an unsurprising event. When the prediction model is still early in the training process, it can also be determined that the comparison is indeterminate because the model is not yet accurate/mature enough to discriminate surprising events from unsurprising events. The determination of the accuracy of the prediction model can be based the size of the corpus of training data (i.e., the number of observations of the given event sequence) a convergence of results from an error function representing the state of training for the prediction model, or other factors representative of the accuracy of the prediction model.

According to some examples, in query 412, the method decides the next step of the method based on the accuracy of the prediction model and based on the agreement/comparison of the actual next event with the predictions.

According to certain non-limiting examples, when the result of query 412 is “yes,yes” (i.e., the mode is accurate and the actual next event disagrees with the predicted next event(s)), then query 412 proceeds to step 414.

When the result of query 412 is “yes,no” (i.e., the mode is accurate and the actual next event agrees with the predicted next event(s)), then query 412 proceeds to step 408. Alternatively, when the result of query 412 is “yes,no,” query 412 can proceed to step 402 (without passing through step 414) to continue refining the prediction model by adding the observation of the given pulse sequence concatenated with the actual next event to the corpus of training data. Thus, the prediction model can continue to improve through reinforcement learning.

When the result of query 412 is “no,--” (i.e., the mode is determined to not be accurate and either result, either agree or disagree, is determined for the actual and predicted next event), then the agreement (or lack thereof) between the actual and predicted next events is ignored and methods 400 returns to step 402 to continue refining the prediction model.

According to some examples, the method includes signaling suspicious next event at step 414. This signal might be logged in a log file or sent to a security operations center (SOC) for review. According to certain non-limiting examples, step 414 can then proceed to step 408 to determine whether subsequent events are surprising. Alternatively, step 414 can then proceed to step 408 to continue refining the prediction model by using the actual next event as an additional observation with which to expand the corpus of training data. When the actual next event is a surprising event, additional information might be helpful for developing the prediction mode. For example, the SOC can confirm that the next event is undesirable (e.g., results from a bug) or is indicative of malicious activity. Alternatively, the SOC can indicate that the signal is a false positive for a surprising event. The feedback from the SOC can then be used to label the event sequence including the actual next event, which is added to the corpus of training data (i.e., the program traces or observations of the program) that is used for reinforcement learning or statistical modeling to improve the prediction model.

Consider for example the program “cURL” (i.e., cURL stand for “Client for URL”), which is used for sending data to and/or receiving data from a server. In the upward mode, cURL opens a socket, then performs a write-heavy sequence of system calls (i.e., more written bytes than read), which is then terminated by closing the socket. In the downward mode, the socket is used in a “read-heavy” model, bracketed by an open/close. Both behaviors are typical of curl and only a few invocations in each direction would be necessary to train the prediction model regarding what constitutes normal behavior. Once the prediction model is trained, any deviation from these sequences of system calls would indicate “surprise.” Examples of surprising behavior for the cURL function might be an instantiation of a previously unseen system call in the sequence or another deviation from expected behavior.

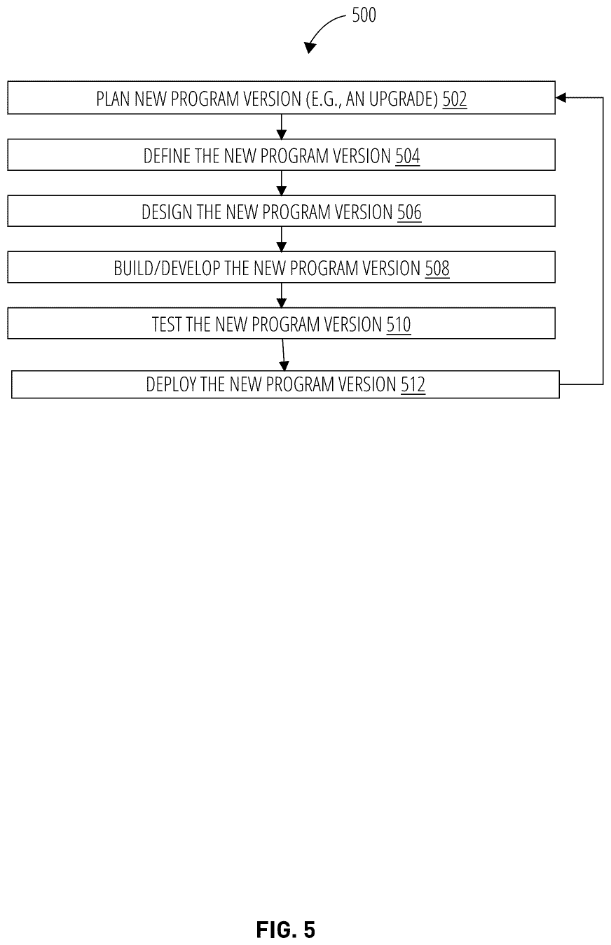

FIG. 5 illustrates an example of method 500 for a software development life cycle (SDLC). Although the example method 500 depicts a particular sequence of operations, the sequence may be altered without departing from the scope of the present disclosure. For example, some of the operations depicted may be performed in parallel or in a different sequence that does not materially affect the function of method 500. In other examples, different components of an example device or system that implements method 500 may perform functions at substantially the same time or in a specific sequence.

Method 500 provides a structured process to enable high-quality, low-cost program development in a short period. Method 500 can produce a program version that meets customer expectations with minimal interruption.

According to some examples, in step 502, the method includes planning a new program version (e.g., an upgrade).

According to certain non-limiting examples, step 502 includes planning and requirement analysis. Requirement analysis can be performed by the senior members of the team with inputs from the customer, the sales department, market surveys, and domain experts in the industry. This information can be used to plan the basic project approach based on studies in the economic, operational, and technical areas.

According to some examples, in step 504, the method includes defining the program version at step 504.

According to certain non-limiting examples, upon completion of the requirement analysis, the product requirements can be defined and documented. Further, these product requirements can be approved by the customer or the market analysts. This can be done using a software requirement specification (SRS) document which consists of all the product requirements to be designed and developed during the project life cycle.

According to some examples, in step 506, the method includes designing the program version at step 506.

According to certain non-limiting examples, the SRS is used as the reference for product architects to come out with the best architecture for the product to be developed. Based on the requirements specified in SRS. According to certain non-limiting examples, more than one design approach can be proposed for the product architecture is proposed and documented in a DDS-Design Document Specification.

This DDS is reviewed by various stakeholders and a preferred design approach is selected based on various selection criteria (e.g., based on various parameters such as risk assessment, product robustness, design modularity, budget, and time constraints). A design approach defines the architectural modules of the product along with its communication and data flow representation with the external and third-party modules (if any).

According to some examples, in step 508, the method includes building/developing the program version at step 508.

According to certain non-limiting examples, in step 508 the development is performed and the product is built. The programming code is generated as per DDS during this step. Developers follow the coding guidelines defined by their organization and programming tools like compilers, interpreters, debuggers, etc. are used to generate the code. Different high-level programming languages such as C, C++, Pascal, Java, and PHP are used for coding.

According to some examples, in step 510, the method includes testing the program version at step 510.

According to certain non-limiting examples, step 510 can include parts of all stages of the SDLC cycle, and can thus be viewed as a subset of all the stages of the SDLC model. Further, some testing activities can be integrated with other stages of method 500. Once a code commit is ready, testing can proceed by provisioning the code commit in a staging environment that is intended to be representative of how the new version will be used in practice. Then, testing proceeds by measuring various signals to determine that the product/new version functions as desired. Generally, step 510 can include testing the product/new version for defects, bugs, or security vulnerabilities, and then reporting, tracking, fixing, and retesting the defects, bugs, or security vulnerabilities, until the product reaches the quality standards and passes a quality assurance (QA) process.

According to some examples, in step 512, the method includes deploying the program version. In step 512, the new version can be deployed by provisioning it in a production environment, and new version can be tested by performing additional testing in the production environment to ensure that the new version functions as desired.

According to certain non-limiting examples, method 600 (discussed below) can be used to test and/or monitor the new version of a program to flag/signal surprising behavior during the testing and/or deployment of the new version of the program. Alternatively, method 600 can be combined with, rather than replace, previous methods of verification testing (e.g., step 510) that exist as a normal course of the Software Development Lifecycle (SDLC). For example, code commits can be continuously integrated and tested in a staging environment using method 600, prior to the use of the new version of the program in a production environment. Once staging-phase testing is complete, the code can merged into the production branch and pushed into production.

Failures (e.g., defects, bugs, or vulnerabilities) detected using method 600 can indicate a field escape of a bug that was missed during the QA process (e.g., the testing in step 510). Thus, the production/deployment testing using method 600 provides a way to prevent the bug from negatively impacting production by doing out-of-band verification within the actual production environment, but in a manner that is not disruptive and/or is invisible to the customer (e.g., without the disruption of software rollbacks).

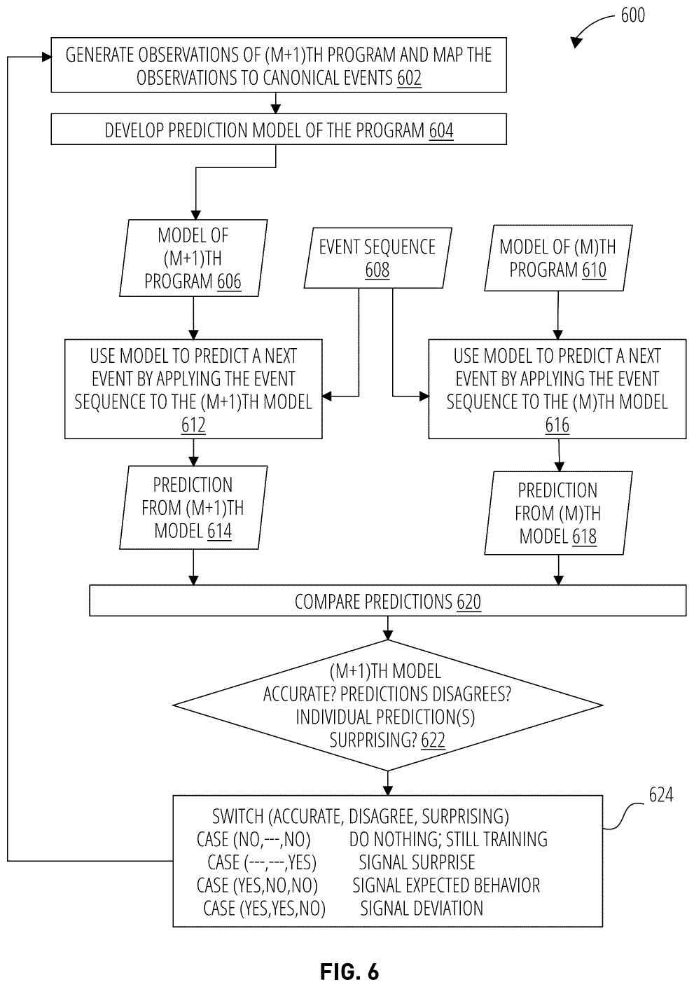

FIG. 6 illustrates an example a method 600 for identifying behavioral deviations between different implementations/versions of a program. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

Method 600 is related to method 400 with the difference being that in method 400 two program models are being developed for two different versions of the program. For example, the current version of the program can be labeled as the (M)th program, and the prediction model for the behavior of the (M)th program can be referred to as the (M)th model. Similarly, the upgrade version of the program can be labeled as the (M+1)th program, and the prediction model for the behavior of the (M+1)th program can be referred to as the (M+1)th model. According to certain non-limiting examples, the (M)th program can have been previously developed, in view of the current version of the program (i.e., the (M)th program) presumably having been operating for a considerable amount of time. The upgrade version of the program will presumably be newer and may not have been operating for a considerable amount of time. Accordingly, method 600 considers the non-limiting example in which the model 610 of (M+1)th program already exists and the model 606 of (M+1)th program is still being developed (e.g., trained using observations of program traces of the (M+1)th program).

According to some examples, in step 402, the method includes generating observations of (m+1)th program and mapping the observations to canonical events at step 602. This can be performed similarly to step 402 and step 404 of method 400.

According to some examples, in step 604, the method includes developing a prediction model of the program (e.g., model 606 of (M+1)th program). This can be performed similarly to step 406 of method 400.

Relatedly, the model 610 of (M+1)th program can already exist due to having been previously generated in a manner similar to step 602 and step 604 being performed for the (M) th program. Also, similar to method 400, the event sequence 608 can be obtained from a current program trace derived from observations of the (M+1)th program.

According to some examples, in step 612, the method includes applying the event sequence 608 to the (M+1)th model 606 to generate predictions 614 from (M+1)th model 606 (e.g., to predict a next event and/or respective likelihoods for possible next events).

Similarly, in step 616, the method includes applying the event sequence 608 to the (M) th model 610 to generate predictions 618 from (M)th model 610 (e.g., to predict a next event and/or respective likelihoods for possible next events).

According to some examples, in step 620, the prediction 614 from (M+1)th model 606 is compared to the prediction 618 from (M)th model 610.

According to certain non-limiting examples, the comparison can be performed by comparing the differences between predicted probabilities between the respective models. For example, the prediction 614 from (M+1)th model 606 can be represented as the conditional probability of e[n] occurring given the sequence of events e[n−1], . . . , et[1], which is expressed as

$${P}_{( M + 1 ) th} ( e [ n ] \vert e [ n - 1 ] , … , e [ 1 ] ) .$$

Additionally, the prediction 618 from (M)th model 610 can be represented as the conditional probability of event [n] occurring given the sequence of events event[n−1], . . . , event[1], which is expressed as

$${P}_{( M ) th} ( e [ n ] \vert e [ n - 1 ] , … , e [ 1 ] ) .$$

The comparison between the two models can be calculated by taking the L-norm between the respective conditional probabilities for a total of J possible next events (i.e., eⱼ[n] is the jth possible next event wherein j=1, 2, . . . , J). For example, the comparison metric (CM) can be calculated using the LP-norm of the difference between the arrays or conditional probabilities, which can be expressed as

$$CM = {( {\sum }_{j = 1 … J} {\vert {P}_{( M + 1 ) th} ( {e}_{j} [ n ] \vert e [ n - 1 ] , … , e [ 1 ] ) - {P}_{( M ) th} ( {e}_{j} [ n ] \vert e [ n - 1 ] , … , e [ 1 ] \vert}^{p} )}^{1 / p} .$$

Here, the value of the comparison metric CM is based on a norm of differences between first values based on the first conditional probabilities and second values based on the second conditional probabilities. And the first values are the first conditional probabilities and the first values are the second conditional probabilities.

Additionally or alternatively, the comparison metric (CM) can be calculated using logarithms of the conditional probabilities, wherein

$${a}_{j}^{( M + 1 ) th} = - ln ( {P}_{( M + 1 ) th} ( {e}_{j} ) [ n ] \vert e [ n - 1 ] , … , e [ 1 ] ) )$$

and the comparison metric (CM) can be calculated as LP-norm of the difference between the vector

$${a}^{( M + 1 ) th} = [ {a}_{1}^{( M + 1 ) th} , {a}_{2}^{( M + 1 ) th} , … , {a}_{J}^{( M + 1 ) th} ]$$

and vector

$${a}^{( M ) th} = [ {a}_{1}^{( M ) th} , {a}_{2}^{( M ) th} , … , {a}_{J}^{( M ) th} ]$$

such that

$$CM = {( {\sum }_{j = 1 … J} {\vert {a}_{j}^{( M + 1 ) th} - {a}_{j}^{( M ) th} \vert}^{p} )}^{1 / p} .$$

Here, the value of the comparison metric CM is based on a norm of differences between first values based on the first conditional probabilities and second values based on the second conditional probabilities. And the first values are logarithms of the first conditional probabilities and the second values are logarithms of the second conditional probabilities.

Additionally or alternatively, the comparison metric CM can be calculated using the product of the conditional probabilities with the logarithms of the conditional probabilities (e.g., related to the entropy),

wherein

$${b}_{j}^{( M + 1 ) th} = - {P}_{( M + 1 ) th} ( {e}_{j} [ n ] \vert e [ n - 1 ] , … , e [ i ] ) \times ln ( {P}_{( M + 1 ) th} ( {e}_{j} [ n ] \vert e [ n - 1 ] , … , e [ 1 ] ) )$$

and the comparison metric (CM) can be calculated as LP-norm of the difference between the vector

$${b}^{( M + 1 ) th} = [ {b}_{1}^{( M + 1 ) th} , {b}_{2}^{( M + 1 ) th} , … , {b}_{J}^{( M + 1 ) th} ]$$

and vector

$${b}^{( M ) th} = [ {b}_{1}^{( M ) th} , {b}_{2}^{( M ) th} , … , {b}_{J}^{( M ) th} ]$$

such that

$$CM = {( {\sum }_{j = 1 … J} {\vert {b}_{j}^{( M + 1 ) th} - {b}_{j}^{( M ) th} \vert}^{p} )}^{1 / p} .$$

Here, the value of the comparison metric CM is based on a norm of differences between first values based on the first conditional probabilities and second values based on the second conditional probabilities. And the first values are products of negatives of the first conditional probabilities times the logarithms of the first conditional probabilities and the second values are products of negatives of the second conditional probabilities times logarithms of the second conditional probabilities.

According to certain non-limiting examples, the comparison metric CM can be a number of possible next events for which the conditional probability for the model 606 of (M+1) th program differs from the conditional probability for the model 610 of (M+1)th program by more than a predefined amount or percentage.

According to certain non-limiting examples, the comparison metric CM can be weighted to emphasize deviations between the conditional probability for the model 606 of (M+1) th program differs from the conditional probability for the model 610 of (M+1)th program for next events that are recognized to cause problems (e.g., next events that are more highly correlated with common vulnerabilities and exposures (CVEs)).

According to some examples, in query 622, the method performs and inquiry as to whether: (i) the model 606 of (M+1)th program is sufficiently accurate to render reliable predictions for the event sequence 608; (ii) whether the prediction from (M+1)th model 606 agrees with the prediction 618 from (M)th model 610; and (iii) whether the either (or both) of predictions 614 and 618 are surprising when considered separately (i.e., the prediction 614 from (M+1)th model 606 differs significantly from the actual next event or the prediction 618 from (M)th model 610 differs significantly from the actual next event).

According to some examples, in step 624, different actions are taken depending on the results of the inquiry. In the non-limiting example illustrated in FIG. 6, the different actions are expressed as a switch statement that is framed as Boolean statements with respect to (i) is the model 606 of (M+1)th program accurate: (ii) do the predictions 614 disagree with the predictions 618; (iii) do the predictions 614 disagree with the predictions 618 disagree with the actual next event (i.e., are surprising).

In the first case (i.e., the results are (i) “No”; (ii) either “Yes” or “No”; and (iii) “No”), no action is taken with respect to the results because the model 606 of (M+1)th program is still being trained and its results are not yet deemed reliable and the results from the model 610 of (M+1)th program do not indicate a surprise event.

In the second case (i.e., the results are (i) “Yes” or “No”; (ii) either “Yes” or “No”; and (iii) “Yes”), a surprise event is signaled (e.g., similar to step 414). In this case either the model 606 of (M+1)th program, the model 610 of (M+1)th program, or both have deviated significantly from the actual next event, suggesting that further investigation may be merited.

In the third case (i.e., the results are (i) “Yes”; (ii) “No”; and (iii) “No”), the method signals that the (M+1)th program as behaving as expected. For example, the (M+1)th program as behaving consistently with (M)th program, and neither of the models is behaving in a surprising manner with respect to the actual next event. According to certain non-limiting examples, this case might be the most common result, once the model 606 of (M+1)th program is fully trained. Thus, this result might be signaled by doing nothing (e.g., no news is good news) and limiting explicit signals to those cases in which the predictions are either surprising with respect to the actual next event (i.e., the second case) or the predictions disagree indication a deviation between the models (i.e., the fourth case).

In the fourth case (i.e., the results are (i) “Yes”; (ii) “Yes”; and (iii) “No”), a deviation between the models is signaled. In this case, the prediction 614 from the model 606 of (M+1) th program disagrees with the prediction 618 from the model 610 of (M+1)th program. This could be because the (M+1)th program is misbehaving, or deviation may result from a desired improvement relative to the (M)th program. In either case, flagging the deviation may be insightful for analyzing the behavior of the (M+1)th program.

According to certain non-limiting examples, the fourth case may also include results (i) “Yes”; (ii) “Yes”; and (iii) “Yes” because the deviation between the (M+1)th program and the (M)th program will result in the actual next event generated by the (M+1)th program being a surprising event when compared to the prediction 618 from (M)th model 610.

Accordingly, in certain non-limiting examples, the surprising events for the (M) th program can be determined by comparing the prediction 618 from (M)th model 610 to an actual next event that is generated using the (M)th program (i.e., the next event produced by the (M) th program executing the event sequence 608), whereas the surprising events for the (M+1) th program can be determined by comparing the prediction 614 from (M+1)th model 606 to an actual next event that is generated using the (M+1)th program (i.e., the next event produced by the (M+1)th program executing the event sequence 608).

According to certain non-limiting examples, the surprise events in method 600 are determined based solely on comparing the prediction 614 from (M+1)th model 606 to an actual next event that is generated using the (M+1)th program, and surprise events with respect to the (M)th program are not considered in method 600.

According to certain non-limiting examples, the surprise events are not considered in method 600, and method 600 considers only the first two Boolean values (i.e., whether: (i) the model 606 of (M+1)th program is sufficiently accurate to render reliable predictions for the event sequence 608 and (ii) whether the prediction 614 from (M+1)th model 606 agrees with the prediction 618 from (M)th model 610).

Alternatively or additionally, method 600 can generate conditional probabilities for prediction 614 from (M+1)th model 606 that are given by

$$P ( e [ 1 ] , … , e [ N ] \vert Model [ M + 1 ] ) .$$

This conditional probability represents the likelihood of the event sequence e [1], . . . , e [N] conditioned on the program being the (M+1)th program. Similarly, the conditional probabilities for prediction 618 from (M)th model 610 can be given by

$$P ( e [ 1 ] , … , e [ N ] \vert Model [ M ] ) .$$

As discussed above, the comparison metric CM can be calculated as the difference between the conditional probabilities corresponding to the respective models. For example, the value of the comparison metric CM is based on a norm of differences between first values based on the first conditional probabilities and second values based on the second conditional probabilities. And the first values are the first conditional probabilities and the first values are the second conditional probabilities.

Additionally or alternatively, the comparison metric CM can be calculated as the difference between the logarithms of the conditional probabilities corresponding to the respective models. For example, the value of the comparison metric CM is based on a norm of differences between first values based on the first conditional probabilities and second values based on the second conditional probabilities. And the first values are logarithms of the first condition al probabilities and the second values are logarithms of the second conditional probabilities.

Additionally or alternatively, the comparison metric CM the comparison metric CM can be calculated as the difference between the product of the conditional probabilities with the logarithms of the conditional probabilities corresponding to the respective models. For example, the value of the comparison metric CM is based on a norm of differences between first values based on the first conditional probabilities and second values based on the second conditional probabilities. And the first values are products of negatives of the first conditional probabilities times the logarithms of the first conditional probabilities and the second values are products of negatives of the second conditional probabilities times logarithms of the second conditional probabilities.

When using conditional probabilities that are conditioned on the respective models, the query 622 can compare the two probability estimates (e.g., P(e[1], . . . , c[N]|Model[M+1]) and P(e[1], . . . , e[N]|Model[M])) to determine whether surprising events occur based on the model 606 of (M+1)th program and/or the model 610 of (M+1)th program.

In a first case, surprise is determined for both the model 606 of (M+1)th program and the model 610 of (M+1)th program. In this case, the surprising behavior (e.g., suspicious event) is signaled, as in step 414.

In a second case, surprise is determined for the model 610 of (M+1)th program but not for the model 606 of (M+1)th program. In this case, different actions are taken depending on whether the model 606 of (M+1)th program is sufficiently trained to be deemed reliable for making accurate predictions. When the model 606 of (M+1)th program is not yet fully trained and deemed to be reliable (i.e., the model is still being trained), the event(s) can be signaled as being a possible unexpected deviation from the desired behavior. When the model 606 of (M+1)th program is sufficiently trained and deemed to be reliable, the event(s) can be signaled as an expected deviation between the behaviors of the two models.

In a third case, surprise is determined for the model 606 of (M+1)th program but not for the model 610 of (M+1)th program. In this case, different actions are taken depending on whether the model 606 of (M+1)th program is sufficiently trained to be deemed reliable for making accurate predictions. When the model 606 of (M+1)th program is not yet fully trained and deemed to be reliable (i.e., the model is still being trained), then there is no action taken because the model 606 of the (M+1)th program is not yet deemed reliable to detect surprise behavior. When the model 606 of (M+1)th program is sufficiently trained and deemed to be reliable, the event(s) can be signaled as an expected deviation between the behaviors of the two models.

In a fourth case, an absence of surprise is determined for both the model 606 of (M+1) th program and the model 610 of (M+1)th program. In this case, no action is taken, unless the implementation includes signaling when the program(s) behave as expected.

When expected deviations between the behaviors of the two models are detected and these expected deviations are due to intentional improvements (e.g., bug fixes) in the upgrade version of the program, then these events would be used as additional observations in the corpus of training data that is used to train of the model (e.g., reinforcement learning).

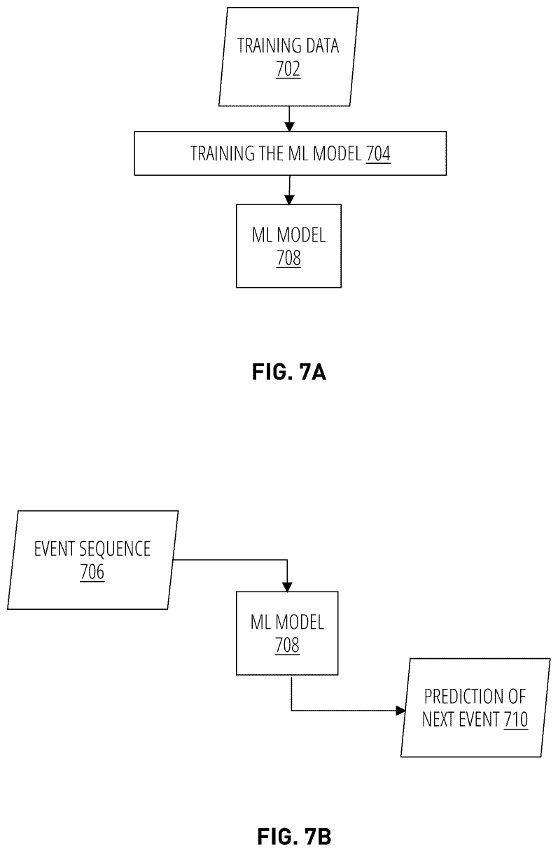

FIG. 7A illustrates an example of training an ML model 708 as a prediction model for a version of a program. In step 704, training data 702 (e.g., sequences of programming events represented as canonicalized program traces or program observations) is applied to train the ML model 708. For example, the ML model 708 can be an artificial neural network (ANN) that is trained via supervised or unsupervised learning using a backpropagation technique to train the weighting parameters between nodes within respective layers of the ANN.

In supervised learning, the training data 702 is applied as an input to the ML model 708, and an error/loss function is generated by comparing the output from the ML model 708 with the desired output (e.g., a known prediction or labels associated with the training data 702). The coefficients of the ML model 708 are iteratively updated to reduce an error/loss function. The value of the error/loss function decreases as outputs from the ML model 708 increasingly approximate the desired output. In other words, ANN infers the mapping implied by the training data, and the error/loss function produces an error value related to the mismatch between the desired output and the outputs from the ML model 708 that are produced as a result of applying the training data 702 to the ML model 708.

Alternatively, for unsupervised learning or semi-supervised learning, training data 702 is applied to train the ML model 708. For example, the ML model 708 can be an artificial neural network (ANN) that is trained via unsupervised or self-supervised learning using a backpropagation technique to train the weighting parameters between nodes within respective layers of the ANN.

In unsupervised learning, the training data 702 is applied as an input to the ML model 708, and an error/loss function is generated by comparing the predictions of the next program event in a sequence of events from the ML model 708 with the actual next event in the event sequence. The coefficients of the ML model 708 can be iteratively updated to reduce an error/loss function. The value of the error/loss function decreases as outputs from the ML model 708 increasingly approximate the training data 702.

For example, in certain implementations, the cost function can use the mean-squared error to minimize the average squared error. In the case of a multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using any of numerous algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribićre update, Powell-Beale restart, and scaled conjugate gradient). Additionally, evolutionary methods, such as gene expression programming, simulated annealing, expectation-maximization, non-parametric methods and particle swarm optimization, can also be used for training the ML model 708.

The training step 704 for training the ML model 708 can also include various techniques to prevent overfitting to the training data 702 and for validating the trained ML model 708. For example, bootstrapping and random sampling of the training data 702 can be used during training.

Further, other machine learning (ML) algorithms can be used for the ML model 708, and the ML model 708 is not limited to being an ANN. For example, there are many machine-learning models, and the ML model 708 can be based on machine-learning systems that include generative adversarial networks (GANs) that are trained. For example, using pairs of network measurements and their corresponding optimized configurations.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

For example, ML model 708 can be a transformer neural network that uses a sequence of events to predict the next event generated by a program. The ML model 708 can use a transformer architecture such as a Bidirectional Encoder Representations from Transformer (BERT) and a Generative Pre-trained Transformer (GPT). The transformer architecture can use an input embedding block to provide representations for event sequences. According to certain non-limiting examples, the representation is a real-valued vector that encodes the meaning of the word in such a way that words that are closer in the vector space are expected to be related events. Event embeddings can be obtained using modeling and feature learning techniques, where event sequences from the program are mapped to vectors of real numbers. According to certain non-limiting examples, the input embedding block can be learned embeddings to convert the input tokens and output tokens to vectors that have the same dimension as the positional encodings, for example.

The positional encodings provide information about the relative or absolute position of the tokens in the sequence. According to certain non-limiting examples, the positional encodings can be provided by adding positional encodings to the input embeddings at the inputs to the encoder 7 and decoder. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that so doing allows the model to extrapolate to sequence lengths longer than the ones encountered during training.

The encoder uses stacked self-attention and point-wise, fully connected layers. The encoder can be a stack of N identical layers (e.g., N=6), and each layer is an encode block, as illustrated by encode block. Each encode block can have two sub-layers: (i) a first sub-layer has a multi-head attention encode block and (ii) a second sub-layer has a feed forward add & norm block, which can be a position-wise fully connected feed-forward network. The feed forward add & norm block can use a rectified linear unit (ReLU).

The encoder can uses a residual connection around each of the two sub-layers, followed by an add & norm multi-head attention block, which performs normalization (e.g., the output of each sub-layer is LayerNorm(x+Sublayer(x)), i.e., the product of a layer normalization “LayerNorm” time the sum of the input “x” and output “Sublayer(x)” pf the sublayer LayerNorm(x+Sublayer(x)), where Sublayer(x) is the function implemented by the sub-layer). To facilitate these residual connections, all sub-layers in the model, as well as the embedding layers, produce output data having the same dimension.

Similarly, the decoder uses stacked self-attention and point-wise, fully connected layers. For example, the decoder can also be a stack of M identical layers (e.g., M=6), and each layer is a decode block. In addition to the two sub-layers (i.e., the sublayer with the multi-head attention encode block and the sub-layer with the feed forward add & norm block), the decode block can include a third sub-layer, which performs multi-head attention over the output of the encoder stack. Like the encoder, the decoder can use residual connections around each of the sub-layers, followed by layer normalization. Additionally, the sub-layer with the multi-head attention encode block can be modified in the decoder stack to prevent positions from attending to subsequent positions. This masking, combined with fact that the output embeddings are offset by one position, ensures that the predictions for position “i” can depend only on the known output data at positions less than “i”.

The linear block can be a learned linear transfor-mation. For example, when the transformer architecture is used to predict the next event from a sequence of events, the linear block projects the output from the last decode block into event scores representing likelihoods that respective events are the next event. For instance, if there are 10,000 possible next events, then 10,000 score values are generated. If there three next events are predicted (i.e., event (N), event (N+1), and event (N+2)), the 10,000 score values would be generated for each position, i.e., each of event (N), event (N+1), and event (N+2). The score values indicate the likelihood of occurrence for each event in the vocabulary of events in that position of the event sequence.

A softmax block can be applied to the scores from the linear block to generate output probabilities (which add up to 1.0). In each position, the index provides for the event with the highest probability, and then map that index to the corresponding word in the vocabulary. Those events then form the output sequence of the transformer architecture. The softmax operation is applied to the output from the linear block to convert the raw numbers into the output probabilities (e.g., token probabilities).

FIG. 7B illustrates an example of using the trained ML model 708. The event sequence 706 is applied to the trained ML model 708 to generate various outputs, which can include the prediction of next event 710.

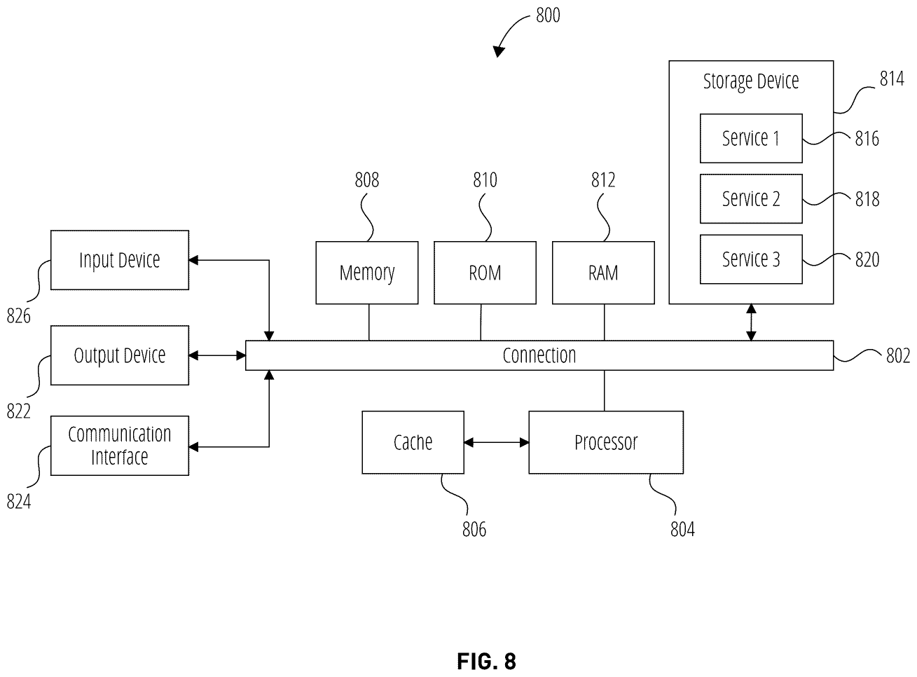

FIG. 8 shows an example of computing system 800. The computing system 800 can be one or more of the components of the data center 100 or the computer network 200 that tests and/or verifies that a new version (e.g., an upgrade) of a program or network policy is ready for deployment. The computing system 800 can perform the functions of one or more of the components of the data center 100 or the computer network 200. The computing system 800 can be part of a distributed computing network in which several computers perform respective steps in method 400, method 500, or method 600 and/or the functions of one or more of the components of the data center 100 or the computer network 200. The computing system 800 can be connected to the other parts of the distributed computing network via connection 802 or communication interface 824. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache of high-speed memory 806 connected directly with, in close proximity to, or integrated as part of processor 804. Processor 804 may essentially be a completely self-contained computing system, containing multiple cores or processors, a bus, memory controller, cache, etc. A multi-core processor may be symmetric or asymmetric.

Processor 804 can include any general-purpose processor and a hardware service or software service, such as services 816, 818, and 820 stored in storage device 814, configured to control processor 804 as well as a special-purpose processor where software instructions are incorporated into the actual processor design.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include a communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that, when the code that defines such software is executed by the processor 804, it causes the system to perform a function. In some embodiments, a hardware service that performs a particular function can include the software component stored in a computer-readable medium in connection with the necessary hardware components, such processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a component of the data center 100 or the computer network 200 and performs one or more functions of method 400, method 500, or method 600 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of detecting differences in behavior for a program, comprising:
obtaining a first prediction model that predicts behavior of a first implementation of a program;
obtaining an event set representing a partially or totally ordered set of events realized from executing the program;
determining, based on observations of a second implementation of the program, a second prediction model of a behavior of the second implementation of the program;
generating, by the first prediction model, a first prediction based on the event set;
generating, by the second prediction model, a second prediction based on the event set;
comparing the first prediction with the second prediction to generate a first comparison result; and
signaling an unexpected behavior of the second implementation of the program when a value of the first comparison result is within a predefined behavior range that has been identified as corresponding to unexpected behavior.

2. The method of claim 1, further comprising:
generating, by the first prediction model, a first prediction of a subsequent event that follows the event set; and
generating, by the second prediction model, a second prediction of the subsequent event that follows the event set.

3. The method of claim 2, wherein
the first prediction model is a statistical model that predicts first conditional probabilities of a plurality of subsequent events given the event set, wherein a conditional probability of a subsequent event of the plurality of subsequent events is a probability of the subsequent event occurring immediately after the event set;
the second prediction model is a statistical model that predicts second conditional probabilities of the plurality of subsequent events given the event set; and
the value of the first comparison result is based on a norm of differences between first values based on the first conditional probabilities and second values based on the second conditional probabilities.

4. The method of claim 3, wherein
the first values are the first conditional probabilities and the first values are the second conditional probabilities; or
the first values are logarithms of the first conditional probabilities and the second values are logarithms of the second conditional probabilities; or
the first values are products of negatives of the first conditional probabilities times the logarithms of the first conditional probabilities and the second values are products of negatives of the second conditional probabilities times logarithms of the second conditional probabilities.

5. The method of claim 1, wherein:
the first implementation of the program is a current version of the program;
the second implementation of the program is an upgrade version of the program;
the program is executed in a cloud computing environment; and
testing the upgrade version before committing the upgrade version to the cloud computing environment includes the comparing of the first prediction with the second prediction to generate the first comparison result and signaling the unexpected behavior of the second implementation of the program when the value of the first comparison result is within the predefined behavior range.

6. The method of claim 1, wherein determining the second prediction model based on observations of a second implementation of the program comprises:
generating records of program traces representing respective sequences of events resulting from executing the second implementation of the program;
mapping the records of program traces to canonical trace events to generate canonicalized records of trace events; and
training the second prediction model using training data comprising the canonicalized records to predict likelihoods of subsequent events in event sets of the second implementation of the program or to predict which subsequent events are unsurprising for respective event sets of the second implementation.

7. The method of claim 6, further comprising:
predicting a confidence metric of the second prediction model;
determining the second prediction is reliable when the confidence metric is within a predefined confidence range;
signaling the unexpected behavior of the second implementation of the program when both the confidence metric is within the predefined confidence range and the value of the first comparison result is within the predefined behavior range; and
signaling that the second prediction is indeterminate when the confidence metric is outside the predefined confidence range.

8. The method of claim 1, further comprising:
comparing second prediction to an actual subsequent event of the second implementation of the program that follows the event set, and thereby generating a second comparison result;
signaling an unexpected behavior of the second implementation of the program when the value of the comparison result is within the predefined behavior range and the second comparison result is within a predefined surprise range; and
signaling an expected deviation of the second implementation of the program when the value of the comparison result is within the predefined behavior range and the second comparison result is outside the predefined surprise range.

9. The method of claim 8, further comprising:
comparing the first prediction to an actual subsequent event of the second implementation of the program immediately following the event set to generate a third comparison result; and
signaling an expected deviation of the second implementation of the program when the value of the comparison result is within the predefined behavior range, the third comparison result is outside the predefined surprise range, and the second comparison result is within the predefined surprise range.

10. A computing apparatus comprising:
a processor; and
a memory storing instructions that, when executed by the processor, configure the apparatus to:
obtain a first prediction model that predicts behavior of a first implementation of a program;
obtain an event set representing a partially or totally ordered set of events realized from executing the program;
determine, based on observations of a second implementation of the program, a second prediction model of a behavior of the second implementation of the program; and
generate, by the first prediction model, a first prediction based on the event set;
generate, by the second prediction model, a second prediction based on the event set;
compare the first prediction with the second prediction to generate a first comparison result; and
signal an unexpected behavior of the second implementation of the program when a value of the first comparison result is within a predefined behavior range that has been identified as corresponding to unexpected behavior.

11. The computing apparatus of claim 10, wherein the instructions stored in the memory further configure the apparatus to:
generate, by the first prediction model, a first prediction of a subsequent event that follows the event set; and
generate, by the second prediction model, a second prediction of the subsequent event that follows the event set.

12. The computing apparatus of claim 11, wherein
the first prediction model is a statistical model that predicts first conditional probabilities of a plurality of subsequent events given the event set, wherein a conditional probability of a subsequent event of the plurality of subsequent events is a probability of the subsequent event occurring immediately after the event set;
the second prediction model is a statistical model that predicts second conditional probabilities of the plurality of subsequent events given the event set; and
the value of the first comparison result is based on a norm of differences between first values based on the first conditional probabilities and second values based on the second conditional probabilities.

13. The computing apparatus of claim 12, wherein
the first values are the first conditional probabilities and the first values are the second conditional probabilities; or
the first values are logarithms of the first conditional probabilities and the second values are logarithms of the second conditional probabilities; or
the first values are products of negatives of the first conditional probabilities times the logarithms of the first conditional probabilities and the second values are products of negatives of the second conditional probabilities times logarithms of the second conditional probabilities.

14. The computing apparatus of claim 10, wherein:
the first implementation of the program is a current version of the program;
the second implementation of the program is an upgrade version of the program;
the program is executed in a cloud computing environment; and
the instructions stored in the memory further configure the apparatus to test the upgrade version before committing the upgrade version to the cloud computing environment includes the comparing of the first prediction with the second prediction to generate the first comparison result and signaling the unexpected behavior of the second implementation of the program when the value of the first comparison result is within the predefined behavior range.

15. The computing apparatus of claim 10, wherein the instructions stored in the memory further configure the apparatus to determine the second prediction model based on observations of a second implementation of the program by:
generating records of program traces representing respective sequences of events resulting from executing the second implementation of the program;
mapping the records of program traces to canonical trace events to generate canonicalized records of trace events; and
training the second prediction model using training data comprising the canonicalized records to predict likelihoods of subsequent events in event sets of the second implementation of the program or to predict which subsequent events are unsurprising for respective event sets of the second implementation.

16. A non-transitory computer-readable storage medium, the computer-readable storage medium including instructions that when executed by a computer, cause the computer to:
obtain a first prediction model that predicts behavior of a first implementation of a program;
obtain an event set representing a partially or totally ordered set of events realized from executing the program;
determine, based on observations of a second implementation of the program, a second prediction model of a behavior of the second implementation of the program;
generate, by the first prediction model, a first prediction based on the event set;
generate, by the second prediction model, a second prediction based on the event set;
comparing the first prediction with the second prediction to generate a first comparison result; and
signal an unexpected behavior of the second implementation of the program when a value of the first comparison result is within a predefined behavior range that has been identified as corresponding to unexpected behavior.

17. The non-transitory computer-readable storage medium of claim 16, wherein the instructions on computer-readable storage medium further cause the computer to:
generate, by the first prediction model, a first prediction of a subsequent event that follows the event set; and
generate, by the second prediction model, a second prediction of the subsequent event that follows the event set.

18. The non-transitory computer-readable storage medium of claim 17, wherein
the first prediction model is a statistical model that predicts first conditional probabilities of a plurality of subsequent events given the event set, wherein a conditional probability of a subsequent event of the plurality of subsequent events is a probability of the subsequent event occurring immediately after the event set;
the second prediction model is a statistical model that predicts second conditional probabilities of the plurality of subsequent events given the event set; and
the value of the first comparison result is based on a norm of differences between first values based on the first conditional probabilities and second values based on the second conditional probabilities.

19. The non-transitory computer-readable storage medium of claim 18, wherein
the first values are the first conditional probabilities and the first values are the second conditional probabilities;
the first values are logarithms of the first conditional probabilities and the second values are logarithms of the second conditional probabilities; or
the first values are products of negatives of the first conditional probabilities times the logarithms of the first conditional probabilities and the second values are products of negatives of the second conditional probabilities times logarithms of the second conditional probabilities.

20. The non-transitory computer-readable storage medium of claim 16, wherein the instructions on computer-readable storage medium further cause the computer to determine the second prediction model based on observations of a second implementation of the program by:
generating records of program traces representing respective sequences of events resulting from executing the second implementation of the program;
mapping the records of program traces to canonical trace events to generate canonicalized records of trace events; and
training the second prediction model using training data comprising the canonicalized records to predict likelihoods of subsequent events in event sets of the second implementation of the program or to predict which subsequent events are unsurprising for respective event sets of the second implementation.
